(19) United States
(12) Patent Application Publication
(10) Pub. No.: US 2011/0061459 A1
(43) Pub. Date: Mar. 17, 2011

(54) Method and Apparatus for Enhancing Measurement Accuracy for Beverage Preparations

(76) Inventors: Ben Farber, St. Petersburg, FL (US); Edmond E. Routhier, Sonoma, CA (US)

(21) Appl. No.: 12/560,607

(22) Filed: Sep. 16, 2009

(51) Int. Cl. G01F 19/00

(52) U.S. Cl. 73/427

(57) ABSTRACT

A measuring device capable of enhancing accuracy of measurements for beverage preparations is disclosed. The measuring device includes a container having an opening. The opening is configured to allow a stream of liquid substance such as milk to enter. The container has a bottom and a side wall, wherein the side wall elevates from the bottom to the opening. The container is capable of retaining the stream of liquid substance. The side wall further includes markers, wherein each marker indicates a measurement of an Ingredient in accordance with the size of the beverage.

### FIELD

The exemplary embodiment(s) of the present invention relates to measurement system. More specifically, the exemplary embodiment(s) of the present invention relates to measuring device for beverage preparations.

### BACKGROUND

A typical measuring cup contains one or more measurement line(s) wherein each measurement line has an associated measurement unit or volume next to the measurement line indicating the measurement and/or capacity. For example, if the measurement line indicates a 16 ounce (“oz”) liquid volume, a symbol of 16 oz is typically printed next to the measurement line. Such conventional measuring cups are widely employed in various settings such as restaurants and coffee shops.

A problem associated with a typical measuring cup is readability because the symbol is often difficult to discern when the liquid substance to be measured covers or blocks the reading of the measurement line(s). In a coffee shop scenario, a barista may, for example, have difficulty times reading the measurement symbol(s) as well as measurement line(s) when the liquid substance such as milk rising above the measurement line(s) and symbol(s). An adjustment process of liquid substance such as milk is typically needed to reach a predefined and/or desirable level of measurement for the liquid substance. The adjustment process usually adds complication as well as additional time for coffee preparations. In addition, a certain amount of liquid substance such as milk is discarded or wasted during the process of adjustment.

### SUMMARY

A measuring device capable of enhancing accuracy of measurements for beverage preparations is disclosed. The measuring device includes a container having an opening. The opening is configured to allow a stream of liquid substance such as milk to enter. The container has a bottom and a side wall, wherein the side wall elevates from the bottom to the opening. The container is capable of retaining the stream of liquid substance. The side wall further includes markers, wherein each marker indicates a measurement of an ingredient in accordance with the size of the beverage.

Additional features and benefits of the exemplary embodiment(s) of the present invention will become apparent from the detailed description, figures and claims set forth below.

### BRIEF DESCRIPTION OF THE DRAWINGS

The exemplary embodiment(s) of the present invention will be understood more fully from the detailed description given below and from the accompanying drawings of various embodiments of the invention, which, however, should not be taken to limit the invention to the specific embodiments, but are for explanation and understanding only.

FIG. 1 is a three-dimensional (“3D”) diagram illustrating a measuring device used for beverage preparations in accordance with one embodiment of the present invention;

FIG. 2 is a 3D diagram illustrating a measuring device used for coffee preparations with specific markers in accordance with one embodiment of the present invention;

FIG. 3 is a 3D diagram illustrating an alternative measuring device used for coffee preparations with specific markers in accordance with one embodiment of the present invention;

FIG. 4AB illustrate a measuring device used for coffee preparations with color inserts in accordance with one embodiment of the present invention;

FIG. 5 is a 3D diagram illustrating a measuring device for beverage preparations using measuring sensors in accordance with one embodiment of the present invention;

FIG. 6 is a 3D diagram illustrating a measuring device used for beverage preparations capable of controlling the liquid dispenser in accordance with one embodiment of the present invention;

FIG. 7 is a pictorial illustration showing a measuring device used for coffee preparations with specific markers in accordance with one embodiment of the present invention;

FIG. 8 is an alternative pictorial illustration showing a measuring device used for coffee preparations with specific markers in accordance with one embodiment of the present invention;

FIG. 9 is a pictorial illustration showing a measuring device used for coffee preparations with alternative markers in accordance with one embodiment of the present invention; and

FIG. 10 is a flowchart illustrating a process of preparing a cup of coffee using a measuring device in accordance with one embodiment of the present invention.

### DETAILED DESCRIPTION

Exemplary embodiment(s) of the present invention is described herein in the context of a method, device, and apparatus of improving accuracy of ingredient measurements for beverage preparations.

Those of ordinary skills in the art will realize that the following detailed description of the exemplary embodiment(s) is illustrative only and is not intended to be in any way limiting. Other embodiments will readily suggest themselves to such skilled persons having the benefit of this disclosure. Reference will now be made in detail to implementations of the exemplary embodiment(s) as illustrated in the accompanying drawings. The same reference indicators will be used throughout the drawings and description to refer to the same or like parts.

In the interest of clarity, not all of the routine features of the implementations described herein are shown and described. It will, of course, be understood that in the development of any such actual implementation, numerous implementation-specific decisions may be made in order to achieve the developer's specific goals, such as compliance with application- and business-related constraints, and that these specific goals will vary from one implementation to another and from one developer to another. It, however, will be understood that such a development effort might be complex and time-consuming, but would nevertheless be a routine undertaking of engineering for those of ordinary skills in the art having the benefit of embodiment(s) of this disclosure.

Various embodiments of the present invention illustrated in the drawings may not be drawn to scale. Rather, the dimensions of the various features may be expanded or reduced for clarity. In addition, some of the drawings may be simplified for clarity. Thus, the drawings may not depict all of the components of a given apparatus (e.g., device) or method.

Unless otherwise defined, all terms (including technical and scientific terms) used herein have the same meaning as commonly understood by one of ordinary skills in the art to which the exemplary embodiment(s) belongs. It will be further understood that terms, such as those defined in commonly used dictionaries, should be interpreted as having a meaning that is consistent with their meaning in the context of the relevant art and this exemplary embodiment(s) of the disclosure unless otherwise defined.

As used herein, the singular forms of article “a”, “an” and “the” are intended to include the plural forms as well, unless the context clearly indicates otherwise. Also, the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The term “and/or” includes any and all combinations of one or more of the associated listed items

A measuring pitcher capable of enhancing accuracy of milk measurements for coffee preparations is disclosed. The pitcher includes a container with an opening for retaining milk. The opening is configured to allow a stream of milk to enter the container. The container has a bottom and a side wall, wherein the side wall elevates from the bottom to the opening. The side wall further includes a “Tall” marker, a “Grande” marker, and a “Venti” marker, wherein each marker indicates a measurement of milk in accordance with the cup size of the coffee.

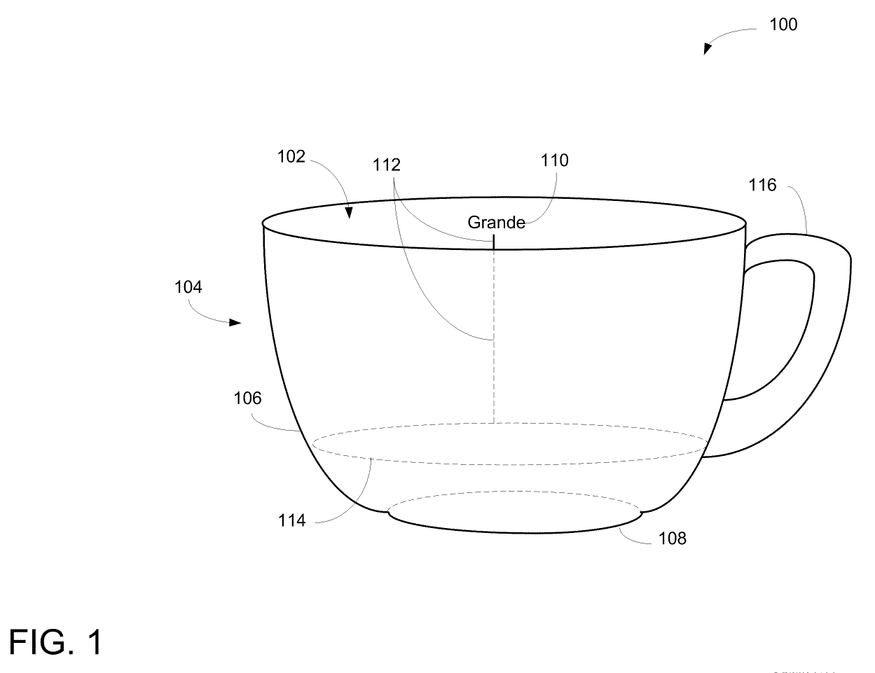

FIG. 1 is a three-dimensional (“3D”) diagram 100 illustrating a measuring device used for beverage preparations in accordance with one embodiment of the present invention. Diagram 100 includes an opening 102 and a container 104 wherein container 104 further includes a side wall 106 and a bottom 108. Side wall 106 elevates or rises from bottom 108 to opening 102 to form a receptacle capable of holding liquid or solid substance. Container 104, in one example, also includes a handle 116 coupled to side wall 106 for hand handling or holding the measuring device. It should be noted that the underlying concept of the exemplary embodiment(s) of the present invention would not change if one or more elements were added to or removed from diagram 100.

Side wall 106, in one embodiment, includes special marker or markers embossed on side wall 106 to enhance readability. For example, a “Grande” marker molded or carved or printed on side wall 106 indicates that measurement 114 pointed by a pointer 112 is the amount of ingredient needed for making a Grande size cup of coffee. Grande size cup, for instance, is able to hold 16 ounce (“oz”) of coffee. Grande size cup, in some instances, is also known as a medium size cup. Note that the marker can include other symbols, such as Tall, Venti, Small, Medium, Large, Mocha, Espresso, Latte, Cappuccino, and the like.

Pointer 112, which is also embossed or printed on side wall 106, includes two ends wherein a first end points to the marker such as Grande while the second end points to measurement 114 indicating the surface of liquid substance. The liquid substance can be milk, cocoa, or syrup. In one embodiment, the second end includes a horizontal dotted line indicating the surface of liquid substance. In an alternative embodiment, various types of color coding inserts are used for measuring the amount of ingredients necessary for preparing a cup of beverage, such as coffee, cocoa, or cold drinks. Coffee can be one of many types of coffee related drinks including, but not limited to, Mocha, Espresso, Latte, Cappuccino, and the like.

Depending on the applications, the measuring device can be made or manufactured by different types of material, such as stainless steel, iron, metal, stainless alloy, glass, plastic, ceramic, polymer, clay, and the like. Also, the design or shape of measuring device can change based on the applications. For example, the measuring device may include a spout with a curved rim for guided pouring of the liquid substance. It should be noted that the shape of the device can be taller and/or the opening can be smaller.

The measuring device, which can be made from any color or transparency in a form of glass, metals, plastics and/or ceramics, is used by a barista to prepare a cup of coffee. A purpose of the embodiment(s) is to pre-measure an amount of milk needed prior to steaming it whereby more accurate measurements for specific sizes of drink can be achieved. Accurate measurement reduces the waste of milk. Other advantages include establishing an enhanced learning curve for new baristas to master minimal coffee standards imposed by corporations such as Starbucks™ or Peet's™. The standards and/or measurements can be described in metrics, English measurement units, or other volume expressions in foreign languages. In addition, the measurements can be set at any angle for readability enhancement.

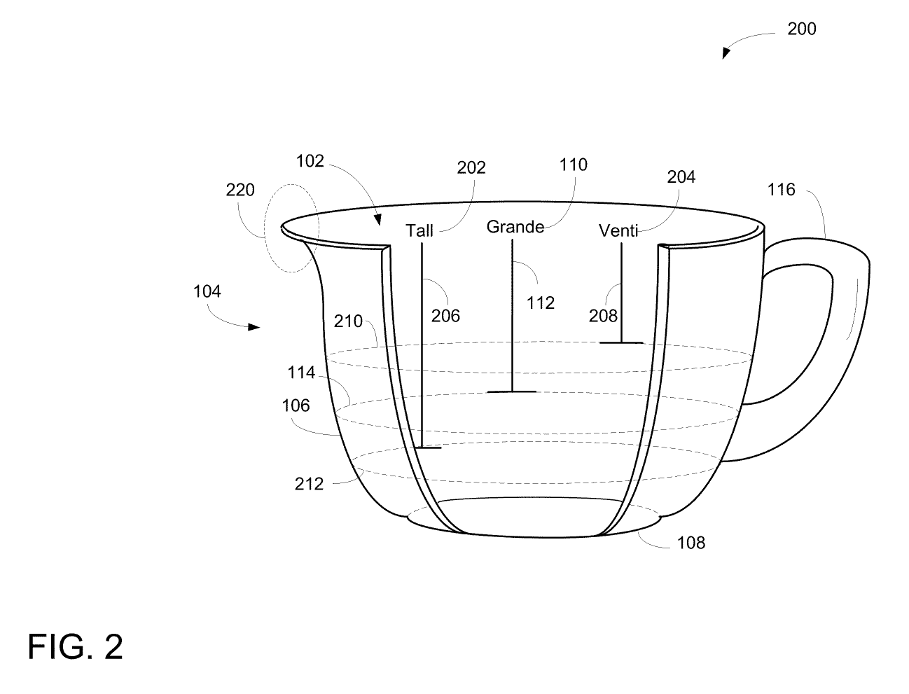

FIG. 2 is a 3D diagram 200 illustrating a measuring device used for coffee preparations with specific markers in accordance with one embodiment of the present invention. Similar to diagram 100 shown in FIG. 1, diagram 200 also includes an opening 102 and a container 104 wherein container 104 further includes a side wall 106 and a bottom 108. Side wall 106 elevates from bottom 108 to opening 102 to form a receptacle capable of holding liquid substance such as milk. Container 104, in one example, also includes a handle 116 coupled to side wall 106 for hand handling or holding the measuring device. Container 104 further includes a spout, mouth, nose, nozzle, or lip 220 for guided liquid pouring or transferring. It should be noted that the underlying concept of the exemplary embodiment(s) of the present invention would not change if one or more elements were added to or removed from diagram 200.

Diagram 200 includes a “Tall” marker, a “Grande” marker, and a “Venti” marker 204 embossed on side wall 106 for enhancing readability. For example, markers 110 and 202-204 are located closer to the rim of opening 102 whereby they can be easily observed by a barista or user. Side wall 106 also includes a tall pointer 206 and a venti pointer 208 wherein the first end of tall pointer 206 points to “Tall” marker 202 while the second end of tall pointer 206 points to a measurement 212 of an ingredient for a “Tall” size cup of coffee. Also, the first end of Venti pointer 208 points to “Venti” marker 204 while the second end of Venti pointer 208 points to a measurement 210 of an ingredient for a “Venti” size cup of coffee. The Tall size cup has different capacity or volume than the Venti size cup. For example, a Tall size cup can hold 12 oz of coffee while a Venti size cup may hold up to 20 oz of coffee.

In one embodiment, the measuring device is configured to have an opening 102 and a container 106. The measuring device is also known as a measuring cup, a measuring pitcher, a measuring jug, a measuring bowl, a measuring glass, and the like. While opening 102 can be referred to as an entrance, container 106 may be referred to as a body. Opening 102 allows a stream of liquid substance to enter or pass, while container 106 retains the stream of liquid substance. The liquid substance, for example, can be milk, Mocha Syrup, Espresso Shot, cocoa, liquid sugar, et cetera.

Side wall 106 includes various markers, wherein each marker indicates a measurement of an ingredient in accordance with the size of beverage. Container 106 can be made of stainless alloy or other types of composite or plastic materials. Container 106 includes a spout for guided pouring of the liquid substance. For example, a barista is able to transfer measured milk from a measuring device to a cup via spout 220. The markers further include a “T+T” symbol and a “T+G” symbol for combined cup sizes. The “T+T” symbol indicates a Tall plus Tall and the “T+G” symbol indicates a Tall plus Grande. Furthermore, the markers can include a “small” marker, a “medium” marker, and a “large” marker, wherein the small marker indicates that a size of small cup can hold 12 oz of drink. The size of a medium cup can hold up to 16 oz of coffee, the size of a larger cup can hold up to 20 oz of liquid beverage.

Grande marker 110 is embossed on side wall 106 toward the rim of opening 102 and includes an embossed line indicating a reading of a measurement. Side wall 106 includes an inside surface and an outside surface, wherein the inside surface includes measurement mechanism capable of detecting the amount of the liquid substance. The outside surface is configured to display said measurement. The markers can include electrical sensors capable of transmitting measurements to a remote location. In addition, a color insert can be coupled to side wall 106 and is capable of changing its color to indicate the level of measurement detected.

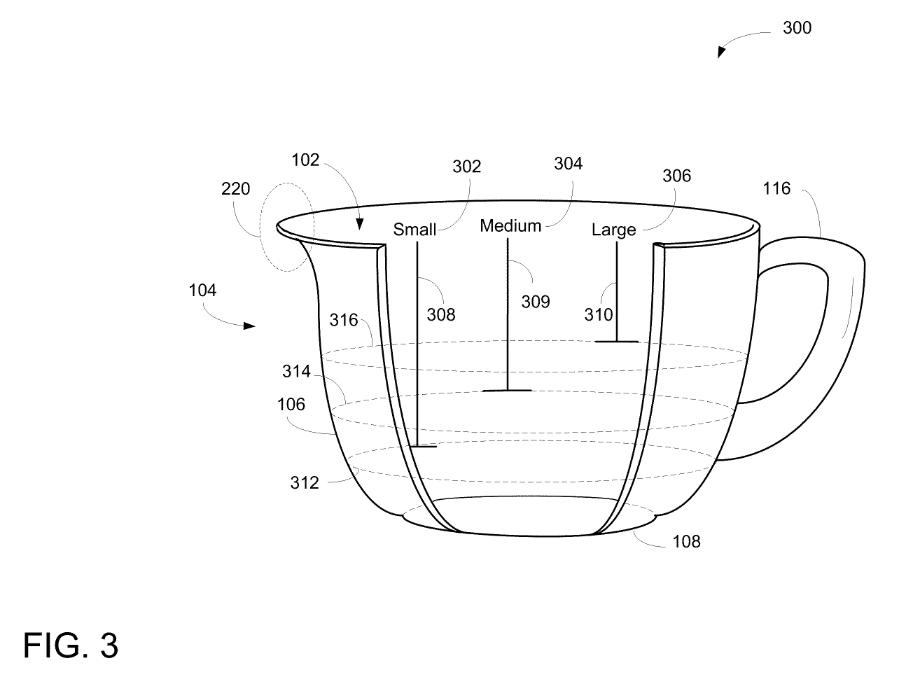

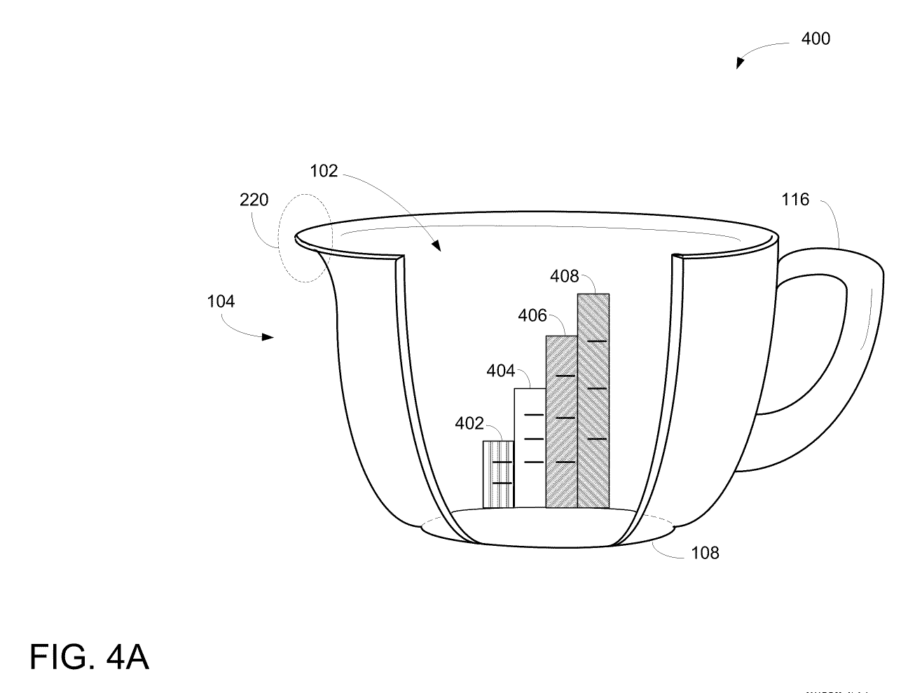

FIG. 3 is a 3D diagram 300 illustrating an alternative measuring device used for coffee preparations with specific markers in accordance with one embodiment of the present invention. Similar to diagram 100 shown in FIG. 1, diagram 300 includes an opening 102 and a container 104 wherein container 104 further includes a side wall 106 and a bottom 108. Side wall 106 elevates from bottom 108 to opening 102 to form a receptacle capable of holding liquid substance such as milk. Container 104, in one example, also includes a handle 116 coupled to side wall 106 for hand handling or holding the measuring device. Container 104 further includes a spout, mouth, nose, nozzle, or lip 220 for guided liquid pouring or transferring. It should be noted that the underlying concept of the exemplary embodiment(s) of the present invention would not change if one or more elements were added to or removed from diagram 300.

The measuring device illustrated in FIG. 3 includes a “Small” marker 302, a “Medium” marker 304, and a “Large” marker 306 embossed on side wall 106, wherein each marker indicates a measurement of an ingredient for a cup of coffee. Side wall 106 further includes a small pointer 308, a medium pointer 309, and a large pointer 310. A small measurement line 312 and small pointer 308 are embossed on side wall 106. Small measurement line 312, for example, indicates the amount of milk needed to prepare for a 12 oz cup of coffee. The first end of small pointer points to “Small” marker 302 and the second end of small pointer points to small measurement line 312. A medium measurement line 314, for example, indicates the amount of milk needed to prepare a 16 oz cup of coffee. The first end of medium pointer points to “Medium” marker 304 and the second end of medium pointer 309 points to medium measurement line 314. A large measurement line 316, for example, indicates the amount of milk needed for a 20 oz cup of coffee. The first end of large pointer 310 points to “Large” marker 306 and the second end of large pointer 310 points to large measurement line 316. Note that different types of coffee related drink may require different amount of ingredients and/or milk.

An advantage of employing the embodiment(s) of the presently illustrated measuring device is to reduce the wasted milk during the preparation of coffee such as a Latte or Mocha. In addition, it simplifies coffee making process thereby the learning curve or training period for new baristas is shortened.

For instance, a measuring device measures the exact amount of milk prior to being steamed regulating in, for example, five (5) different measurements: Venti, Grande, Tall and combinations to Tall+Tall and Tall+Grande of specific cup sizes. The embodiment(s) of the invention reduces milk waste and maximize the value of each drink for a coffee shop, with labeling the different measurements of milk to pour prior to steaming it based on the size of the drink. The inside of the steaming pitchers, for example, can be labeled for specifics based on sizes of drink.

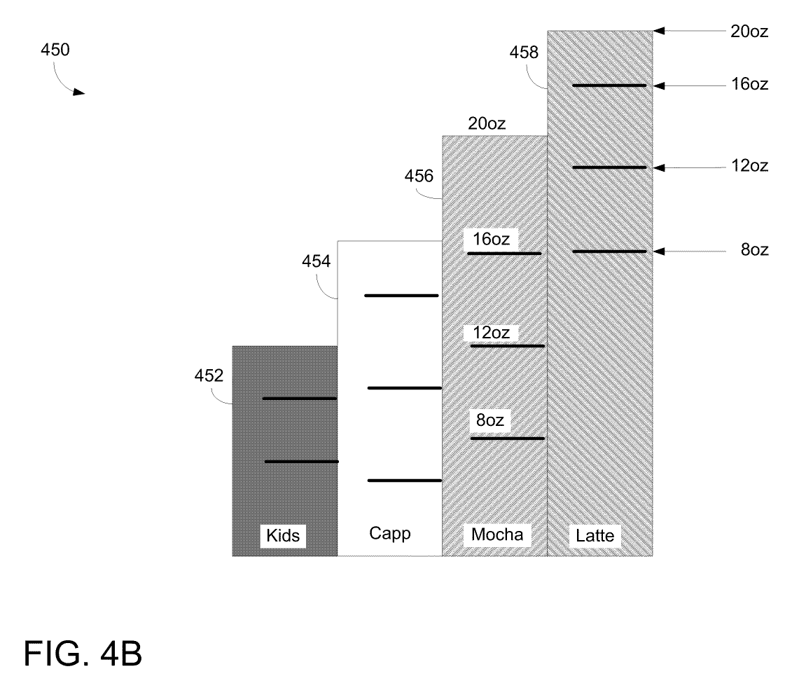

FIG. 4A is a diagram 400 illustrating a measuring device used for coffee preparations with color inserts in accordance with one embodiment of the present invention. Similar to diagram 100 shown in FIG. 1, diagram 400 also includes an opening 102 and a container 104 wherein container 104 further includes a side wall 106 and a bottom 108. Side wall 106 elevates from bottom 108 to opening 102 to form a receptacle capable of holding liquid substance such as milk. Container 104, in one example, also includes a handle 116 coupled to side wall 106 for hand handling or holding the measuring device. Container 104 further includes a spout for guided liquid pouring or transferring. It should be noted that the underlying concept of the exemplary embodiment(s) of the present invention would not change if one or more elements were added to or removed from diagram 400.

The measuring device illustrated in diagram 400 employs one or more sets of color coded measuring inserts 402-408. Each color coded pre-measuring insert, for example, is a pre-determined amount of ingredient needed for preparing a specific size of a drink. Note that different drink sizes can have different capacities, such as 8 oz, 12 oz, 16 oz, 20 oz and so on. Also, beverage can be any types of drink, such as coffee, latte, Mocha, Cappuccino, cocoa, tea, and the like. Each insert can be configured to be usable for preparing one or more types of drinks. In one aspect, a color coded insert can be inserted into a specialized pocket built in the side wall for readability. The insert can be directly inserted into the liquid substance for taking a measurement. Alternatively, measurements can be obtained using color coded inserts, high or low relief imprints, etched, stickers, magnets, and/or internal slips with the measurements.

An advantage of using the inserts is to reduce waster of the liquid substance through the use of a color coded pre-measuring device. To prepare a cup of Latte, the color coded measuring inserts, for example, used in conjunction with standard pitchers for steaming milk, create a near perfect amount of milk for whatever a barista is preparing. Note that the color coded measuring inserts, for one instance, are made of plastic materials and/or heat resistant sticking substances. Another benefit for employing an accurate measuring device is to shorten the learning curve for new a barista's training while serving drinks.

FIG. 4B illustrate a set of color coded measuring inserts 450 used for coffee preparations in accordance with one embodiment of the present invention. A set of color coded measuring inserts 450, in one embodiment, includes a kids insert 452, a cappuccino insert 454, a mocha insert 456, and a latte insert 458, wherein each insert further includes one or more measurement bars indicating unit(s) of capacity. The unit of capacity, as illustrated, is fluid ounce (“fl oz”). In one embodiment, each insert includes a specific predetermined color code representing a specific drink. For example, kids insert 452 is assigned to yellow color and cappuccino insert 454 is assigned to blue color. While mocha insert 456 is assigned to brown color, latte insert 458 is assigned to green color. It should be noted that color codes can be reassigned to different types of drinks.

Each color code contains oz or fl oz measurement bars representing amount of milk needed for each drink. For example, latte insert 458 includes measurement bars for 8 oz, 12 oz, 16 oz, and 20 oz indicating the necessary amount of milk to make or prepare an 8, 12, 16, or 20 oz of latte. Note that measurements account for steamed milk aeration as well as additional ingredients such as Mocha Syrup, Espresso Shot, et cetera. The color coded measuring insert may change its color gradually from one color to another to indicating a process of reaching to a desirable measurement.

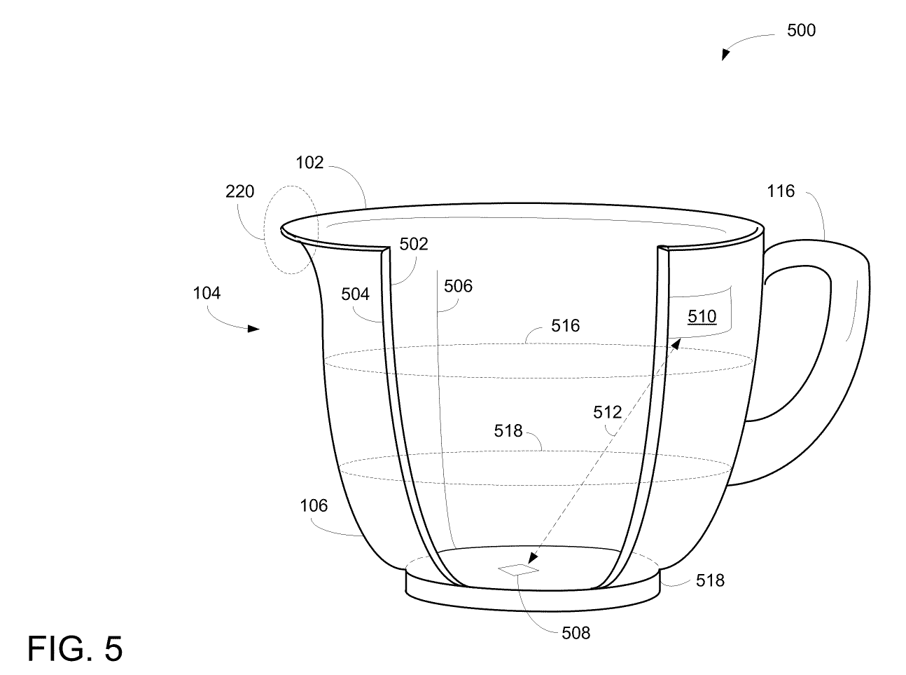

FIG. 5 is a 3D diagram 500 illustrating a measuring device for beverage preparations using measuring sensors in accordance with one embodiment of the present invention. Diagram 500 includes an opening 102 and a container 104 wherein container 104 further includes a side wall 106 and a bottom 518. Side wall 106 elevates from bottom 518 to opening 102 to form a receptacle capable of holding liquid substance such as milk. Container 104, in one example, also includes a handle 116 coupled to side wall 106 for hand handling or holding the measuring device. Container 104 further includes a spout 220 for guided liquid pouring or transferring. It should be noted that the underlying concept of the exemplary embodiment(s) of the present invention would not change if one or more elements were added to or removed from diagram 500.

The measuring device shown in diagram 500 includes a sensor 506 which is capable of detecting various levels of volume for liquid substance. In one embodiment, sensor 506 employs various sensing mechanisms, such as heat sensing, pressure sensing, liquid detecting, motion detecting, optical sensing, and the like. Upon sensing liquid substance, sensor 506 transmits the measurement(s) to a control chip 508. Control chip 508 is capable of processing and converting the measurement(s) to displayable data. After data processing, the measurement detected by sensor 506 is displayed on a display 510. Display 510 is a built-in image displaying element such as a liquid crystal display (“LCD”) or flat panel digital imaging screen situated outside of container 104. Display 510 is able to display measurements 516 or 518 upon receipt of displaying information from chip 508 via communication 512. It should be noted that communication 512 can be a wire or connection traveling from bottom 518 to display 510 via side wall 106. Alternatively, communication 512 can be a wireless communication link.

In one embodiment, the measuring device can be calibrated to a specific setting such as a Grande size (16 oz) Latte. Display 510, for example, displays a green color when the milk starts to dispense into container 104. The green color displayed on display 510 starts to change to yellow as the milk starts to accumulate in container 104. The yellow color begins to change to orange when the milk starts to move closer to the desirable amount of milk. Display 510 displays red color when the milk reaches the desirable amount of milk. It should be noted that display 510 can also be replaced by light emitting diode (“LED”) for illuminating optical color change.

In accordance with the present invention, the components, process steps, and/or data structures described herein may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. Where a method comprising a series of process steps is implemented by a computer or a machine and those process steps can be stored as a series of instructions readable by the machine, they may be stored on a tangible medium such as a computer memory device (e.g., ROM (Read Only Memory), PROM (Programmable Read Only Memory), EEPROM (Electrically Erasable Programmable Read Only Memory), FLASH Memory, Jump Drive, and the like), magnetic storage medium (e.g., tape, magnetic disk drive, and the like), optical storage medium (e.g., CD-ROM, DVD-ROM, paper card and paper tape, and the like) and other known types of program memory.

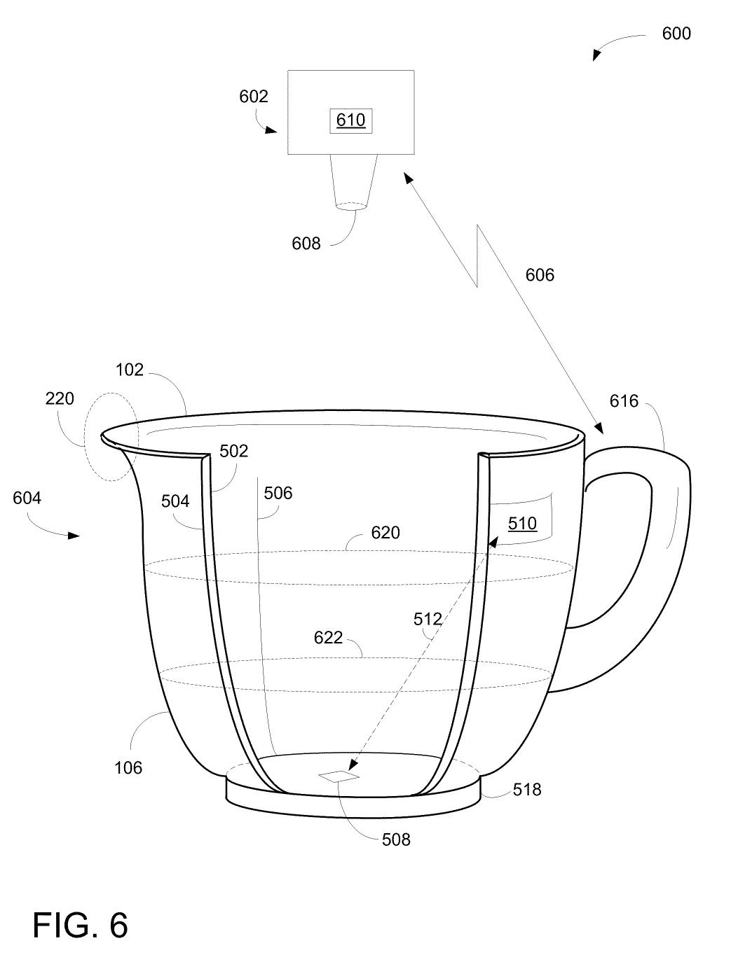

FIG. 6 is a 3D diagram 600 illustrating a measuring device used for beverage preparations capable of controlling the liquid dispenser in accordance with one embodiment of the present invention. Diagram 600 includes a liquid dispenser 602 and a measuring pitcher 604 with an opening 102. Measuring pitcher 604 further includes a side wall 106 and a bottom 518. Side wall 106 elevates from bottom 518 to opening 102 to form a receptacle capable of holding liquid substance such as milk. Measuring pitcher 604, in one example, also includes a handle 116 coupled to side wall 106 for hand handling or holding the pitcher 604. In one embodiment, handle 116 also provides a function of antenna for transmitting wireless signals 606. It should be noted that the underlying concept of the exemplary embodiment(s) of the present invention would not change if one or more elements were added to or removed from diagram 600.

Dispenser 602, in one embodiment, includes a nozzle 608 and a dispensing control unit 610, wherein dispensing control unit 610 gates the liquid flow through nozzle 608 in response to wireless signals 606 emitted by handle 116. During the operation, when sensor 506 detects measurement 620 or 622, chip 508 instructs dispenser 602 to turn on or shut off nozzle 608 via wireless signals 606.

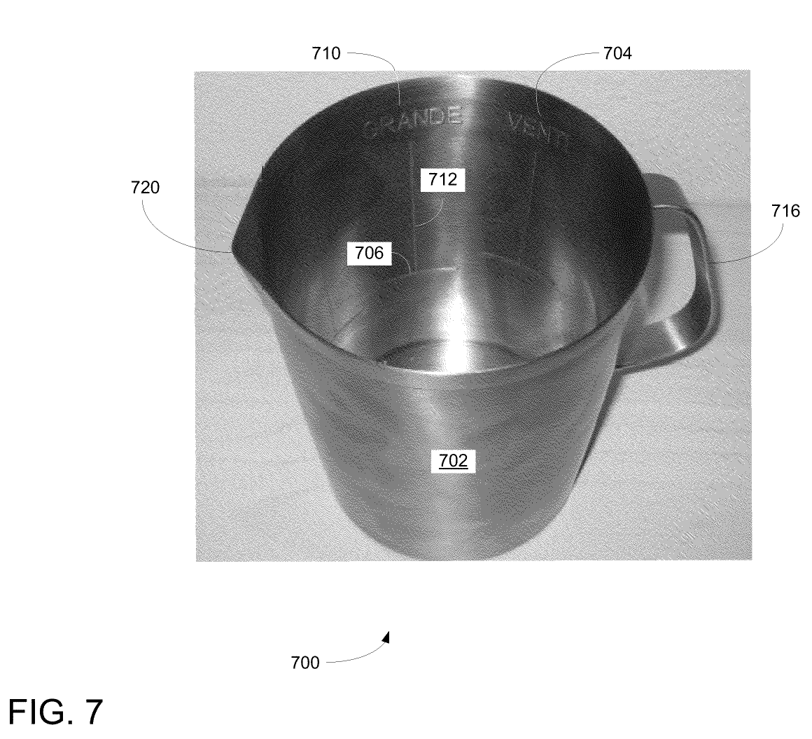

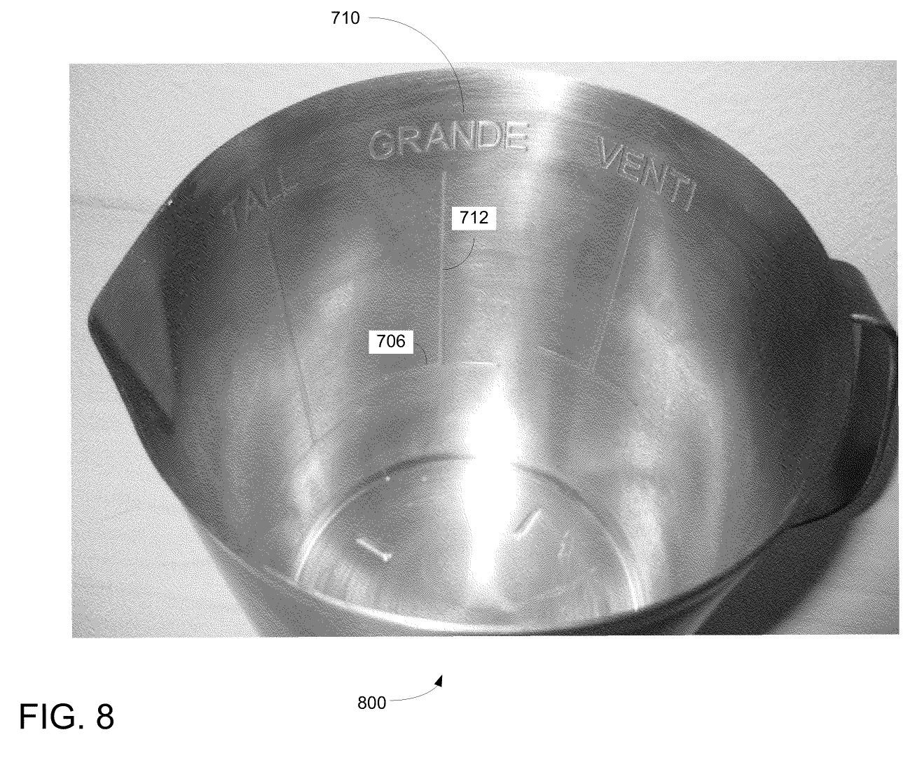

FIG. 7 is a pictorial illustration showing a measuring device 700 used for coffee preparations with specific markers in accordance with one embodiment of the present invention. Device 700 includes a body 702, a handle 716, and a spout 720 wherein device 700 is made of metal or stainless materials. The inside wall of body further includes a “GRANDE” marker 710 and a “VENTI” marker 704. Measuring device 700 also includes pointers and measurement lines such as a Grande pointer 712 and a Grande line 706 embossed on the side wall. FIG. 8 is an alternative pictorial illustration showing a measuring device 800 used for coffee preparations with specific markers in accordance with one embodiment of the present invention. It should be noted that the underlying concept of the exemplary embodiment(s) of the present invention would not change if one or more elements were added to or removed from device 800.

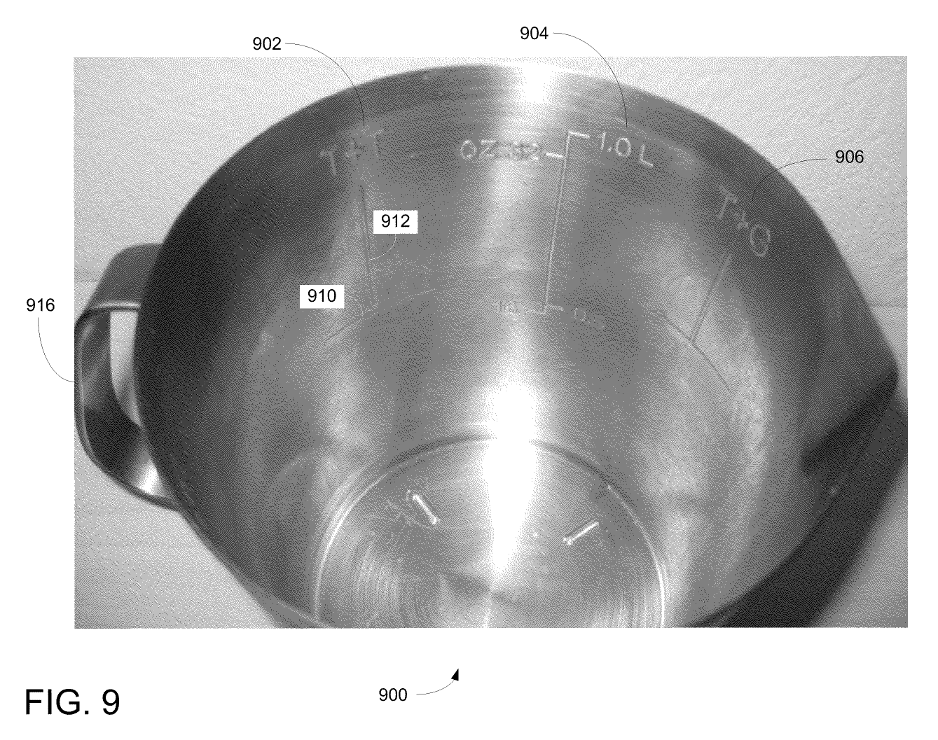

FIG. 9 is a pictorial illustration showing a measuring device 900 used for coffee preparations with alternative markers in accordance with one embodiment of the present invention. Device 900 includes a body, a handle 916, and a spout wherein device 900 is made of metal or stainless materials. The inside wall of body further includes a “T+T” marker 902, a “1.0 L” marker 904, and a “T+G” marker 906. Measuring device 900 also includes pointers and measurement lines such as a T+T pointer 912 and a T+T line 910 embossed on the side wall.

The exemplary aspect of the present invention includes various processing steps, which will be described below. The steps of the aspect may be embodied in machine or computer executable instructions. The instructions can be used to cause a general purpose or special purpose system, which is programmed with the instructions, to perform the steps of the exemplary aspect of the present invention. Alternatively, the steps of the exemplary aspect of the present invention may be performed by specific hardware components that contain hard-wired logic for performing the steps, or by any combination of programmed computer components and custom hardware components.

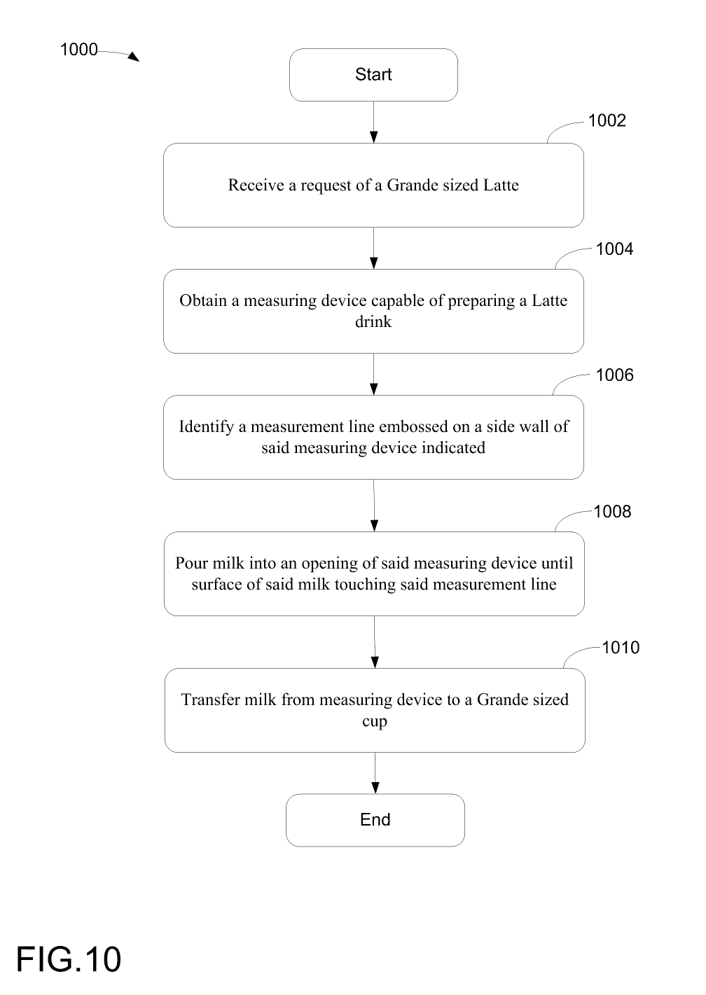

FIG. 10 is a flowchart 1000 illustrating a process of preparing a cup of coffee using a measuring device in accordance with one embodiment of the present invention. At block 1002, a Latte preparing process, in one embodiment, receives a request of a Grande sized Latte. At block 1004, a measuring device capable of preparing a Latte drink is obtained. At block 1006, a barista identifies a measurement line embossed on a wall of the measuring device indicated by a “GRANDE” marker pointed by a pointer. Milk is subsequently, at block 1008, poured into an opening of the measuring device until the surface of the milk touches the measurement line. At block 1010, the milk is transferred from said measuring device into a Grande sized cup.

While particular embodiments of the present invention have been shown and described, it will be obvious to those of skills in the art that based upon the teachings herein, changes and modifications may be made without departing from this exemplary embodiment(s) of the present invention and its broader aspects. Therefore, the appended claims are intended to encompass within their scope all such changes and modifications as are within the true spirit and scope of this exemplary embodiment(s) of the present invention.

What is claimed is:

1. A measuring device, comprising:
an opening configured to allow a stream of liquid substance to enter;
a container having a bottom and a side wall, wherein said side wall elevates from said bottom to said opening, said container capable of retaining said stream of liquid substance; and
wherein said side wall includes a plurality of markers, wherein each said marker indicates a measurement of an ingredient in accordance with size of beverage.

2. The device of claim 1, further comprising a handle coupled to said container.

3. The device of claim 1,
wherein said stream of liquid substance is milk; and
wherein said ingredient is milk.

4. The device of claim 2, wherein said stream of liquid substance includes sugar and cocoa.

5. The device of claim 3, wherein said container is made of stainless alloy.

6. The device of claim 5, wherein said container includes a spout for pouring said liquid substance.

7. The device of claim 6, wherein said beverage is coffee.

8. The device of claim 7, wherein said plurality of markers includes a “Tall” marker, a “Grande” marker, and a “Venti” marker.

9. The device of claim 7, wherein said plurality of markers includes a “small” marker, a “medium” marker, and a “large” marker.

10. The device of claim 8, wherein said “Grande” marker embossed on said side wall toward rim of said opening includes an embossed line indicating a reading of a measurement.

11. The device of claim 8, wherein said side wall includes an inside surface and an outside surface, wherein said inside surface includes measurement mechanism capable of detecting amount of said liquid substance, wherein said outside surface is configured to display said measurement.

12. The device of claim 8, wherein said plurality of markers includes electrical sensors capable of transmitting measurements to a remote location.

13. The device of claim 8, further comprising a color insert coupled to said side wall and capable of changing color of said color insert to indicate level of measurement of said liquid substance.

14. A measuring device, comprising:
an opening capable of allowing milk to enter;
a container having a bottom and a side wall, wherein said side wall raises from said bottom to said opening, said container capable of retaining said milk; and
wherein said side wall includes a “Tall” marker, a “Grande” marker, and a “Venti” marker, wherein each said marker indicates a measurement of an ingredient for a cup of coffee.

15. The device of claim 14, further comprising a handle coupled to said container.

16. The device of claim 15, wherein said container is made of stainless alloy.

17. The device of claim 16, wherein said container includes a spout for pouring said milk to a cup.

18. The device of claim 17, further comprising:
a Tall measurement line and a Tall pointer embossed on said side wall, wherein said Tall measurement line indicates a first measurement of milk and said Tall pointer points to said Tall marker; and
a Grande measurement line and a Grande pointer embossed on said side wall, wherein said Grande measurement line indicates a second measurement of milk and said Grande pointer points to said Grande marker.

19. A measuring device, comprising:
an opening configured to permit milk to enter;
a container having a bottom and a side wall, wherein said side wall elevates from said bottom to said opening, said container capable of retaining said milk, wherein said side wall includes a “Small” marker, a “Medium” marker, and a “Large” marker, wherein each said marker indicates a measurement of an ingredient for a cup of coffee;
a Small measurement line and a Small pointer embossed on said side wall, wherein said Small measurement line indicates a 12 oz measurement of milk and said pointer points to said Small marker; and
a Medium measurement line and a Medium pointer embossed on said side wall, wherein said Medium measurement line indicates a 16 oz measurement of milk and said pointer points to said Medium marker.

20. The measuring method, comprising:
receiving a request of a Grande sized Latte;
obtaining a measuring device capable of preparing a Latte drink;
identifying a measurement line embossed on a side wall of said measuring device indicated by a “GRANDE” marker pointed by a pointer;
pouring milk into an opening of said measuring device until surface of said milk touching said measurement line; and
transferring said milk from said measuring device into a Grande sized cup.
